(19) United States
(12) Patent Application Publication
(10) Pub. No.: US 2004/0173414 A1
(43) Pub. Date: Sep. 9, 2004

(54) Lift installation having a virtual protection area at the bottom and/or the top of the lift shaft, and method for controlling the same

(76) Inventors: Romeo Deplazes, Oberruti (CH); Philipp Angst, Zug (CH)

Correspondence Address: OSTROLENK FABER GERB & SOFFEN, 1180 AVENUE OF THE AMERICAS, NEW YORK, NY, 100368403

(21) Appl. No.: 10/483,204

(22) PCT Filed: Jul. 3, 2002
(86) PCT No.: PCT/CH02/00363

(30) Foreign Application Priority Data
Jul. 9, 2001 (EP) 01810673.2

(51) Int. Cl. B66B 1/28

(52) U.S. Cl. 187/300

(57) ABSTRACT

The invention relates to a lift installation (20) comprising a lift cage (21), a lift shaft (22) and a drive unit (25), the lift cage (21) being moveably installed in the lift shaft (22) and controlled by the drive unit (25) in such a way that it (21) can stop at various positions in the lift shaft (22). Said lift shaft (22) is provided with a detection device (29) for detecting whether a person is in a critical area (32, 33) of the lift shaft (22) or whether the person is about to arrive into one such area. The detection device (29) is connected to the drive unit (25) in such a way that the lift installation (20) can be switched into a special operating mode if a person is in the critical area (32, 33) or about to arrive into the same. The drive unit (25) comprises a special control device (30) which, when the lift installation is in the special operating mode, stops the lift cage (21) before it arrives in the critical area (32, 33). To this end, the detection device (29) and the special control device (30) are designed in an operationally-safe manner in order to prevent the lift cage (21) from entering the critical area (32, 33). When the lift installation is in the special operating mode, the special control device (30) enables the lift cage (21) to be operated in an undisturbed manner in an area outside the critical area (32, 33).

A lift installation comprises, in usual manner, a lift cage, a lift shaft in which the lift cage moves and a drive unit for moving the lift cage.

For reasons of safety, present-day lift installations are designed so that a protective space in the form of a shaft pit is located at the shaft base in order to ensure that maintenance personnel in the shaft are not placed at risk when the lift cage travels into the lowermost position in the shaft. Typically, a lift installation is also designed so that a protective space is located at the upper end of the shaft—called shaft head—so that maintenance personnel undertaking maintenance on the roof of the cage are not put at risk when the cage travels into the uppermost position of the shaft.

This occurs with the most diverse forms of lift layouts, such as, for example, cable lifts, hydraulic lifts, linear motor lifts, etc.

Due to the safety regulation that a protective space has to be provided in the form of a shaft pit at the lower shaft end, the constructional height of the lift shaft is higher than actually necessary from the purely technical aspect.

The protective space at the lower shaft end currently has typically a height of 50 cm plus the length of the buffer compressed to a maximum, the buffer being disposed at the shaft base in order to cushion the counterweight or the lift cage.

A lift installation with protective space at the lower and upper shaft end is longer by a few metres than the actual floor height of the building served by the lift. This frequently leads to solutions in which the lift shaft projects beyond the building. In earlier lift layouts a part of the drive unit was usually mounted in an engine room above the shaft, i.e. either the lift installation was dimensioned so that the uppermost floor was not served, since here the engine room inclusive of protective space was located, or the engine room inclusive of protective space was realised on the roof of the building.

With present-day lift layouts the starting point has fundamentally changed, since increasingly lift installations are realised in which the drive unit is arranged within the shaft space (lift without engine room). Nevertheless, even here a protective space has to be planned in at the lower and/or upper shaft end due to regulations, which can be disadvantageous for the aesthetics of the building.

Apart from the aesthetic and constructional problems which result from the necessity of the protective spaces, these protective spaces cause additional costs in the erection of a building.

In current lift layouts the entire installation is shut down in the case of maintenance. This frequently leads to problems if no other lift is provided in the same building or if the conveying capacity of the other lifts is insufficient.

It is also important with current lift layouts that maintenance, assembly, repair or inspection personnel at the base of the lift shaft or at the head end of the same have access to the various technical and electrical systems.

European Patent Application EP 1052212-A describes equipment which allows work to be carried out in a lift shaft. According to this patent application a protective space is realised at the upper shaft end in that the counterweight is prematurely stopped at the lower shaft end. The cage—which is connected with the counterweight by way of a cable system—thereby cannot be moved up to the shaft head.

U.S. Pat. No. 6,223,861 describes a safety system for a lift in which the lift is moved only at reduced speed if a person stands in the lift shaft. Whether a person stands in the lift shaft is ascertained by sensors at the shaft doors. If the lift moves at reduced speed, special switches at the lower and upper shaft ends stop the cage in order to prevent movement of the cage into the protective space.

Another form of safety system is disclosed in U.S. Pat. No. 6,138,798. In order to ensure the safety of maintenance personnel in the shaft pit, buffers are used, the length of which can be changed. If a person is detected in the region of the shaft pit, the buffers are driven out in order to thus be able to guarantee a protective space of greater height.

A similar approach is known from Japanese Patent Abstract with publication number 0905894, wherein, however, this specification concerns the protection zone at the shaft head.

An electronic safety bus connecting different sensors with a central controller is described in U.S. Pat. No. 6,173,814. A lift installation based on a safety bus of that kind is particularly safe, since the lift can be stopped directly when an exceptional situation is detected.

It is an object of the present invention to eliminate the protective spaces or to reduce the length thereof.

It is a further object of the invention to provide a lift installation with a shortened shaft.

Moreover, it is an object of the invention to reduce the costs of the lift installation.

It is a further object to enhance the safety of maintenance personnel.

It is additionally applicable to provide a lift installation and a corresponding method of controlling the same which can still remain in operation even in the case of maintenance.

These objects are fulfilled by the lift installation claimed in claim 1 and the method claimed in claim 12.

Advantageous developments and improvements are represented in claims 2 to 11 and 13 to 21.

The lift installation according to the invention and the corresponding method offer, depending on the respective form of embodiment, various advantages, such as, for example, an improved building or space utilisation. In addition, lift installations according to the invention are better suited to specially representative buildings and equipment, since due to the shorter mode of construction of the shaft they can be architectonically better integrated into an overall concept. This is particularly important in the case of free-standing lift installations.

Through the special embodiment of the lift installation according to the invention the safety of persons in the lift shaft is ensured at all times and in all circumstances.

The lift installation according to the present invention is distinguished by smaller dead times, since the operation is maintained, even if to restricted extent, during maintenance.

The invention is explained in more detail in the following on the basis of examples of embodiment and illustrated in the drawings, in which:

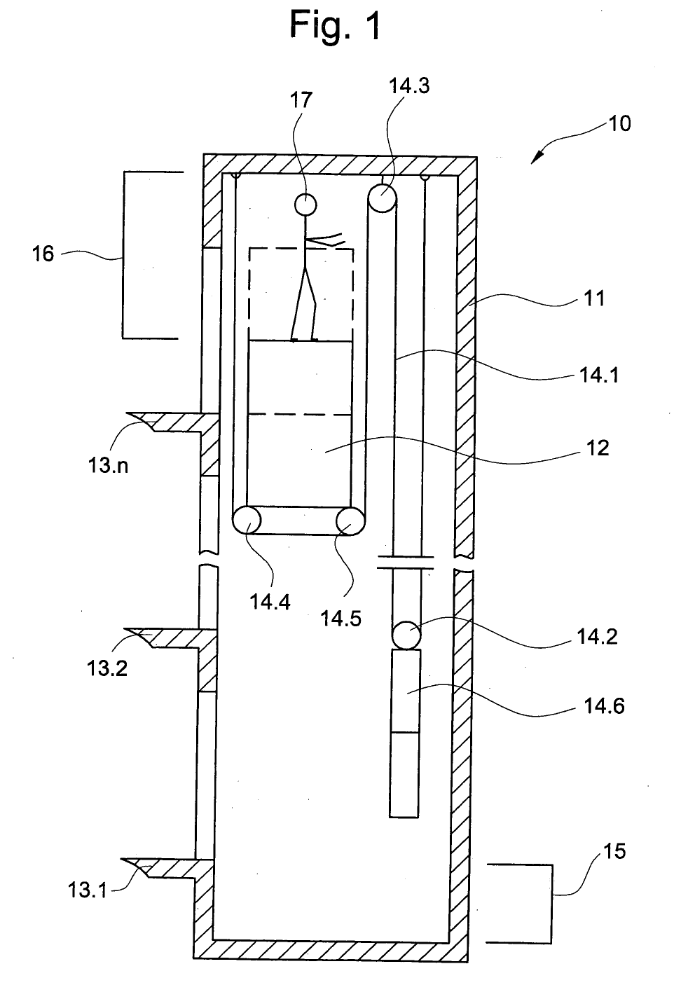

FIG. 1 shows a conventional lift installation in section;

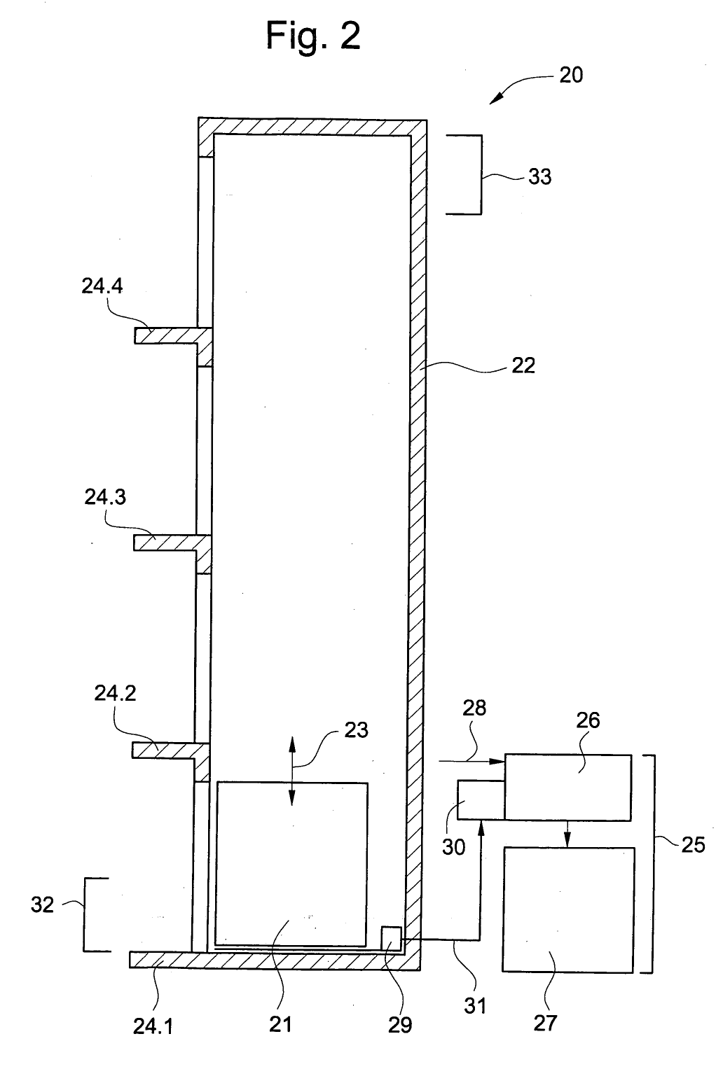

FIG. 2 shows a lift installation according to the invention in section;

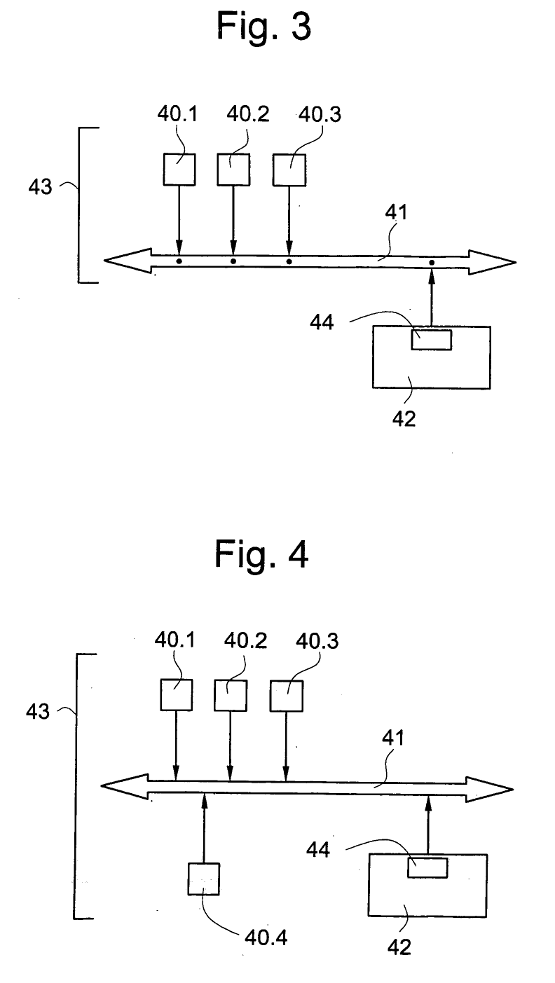

FIG. 3 shows the safety bus of a lift installation according to the invention as a block diagram;

FIG. 4 shows the safety bus of a further lift installation according to the invention as a block diagram;

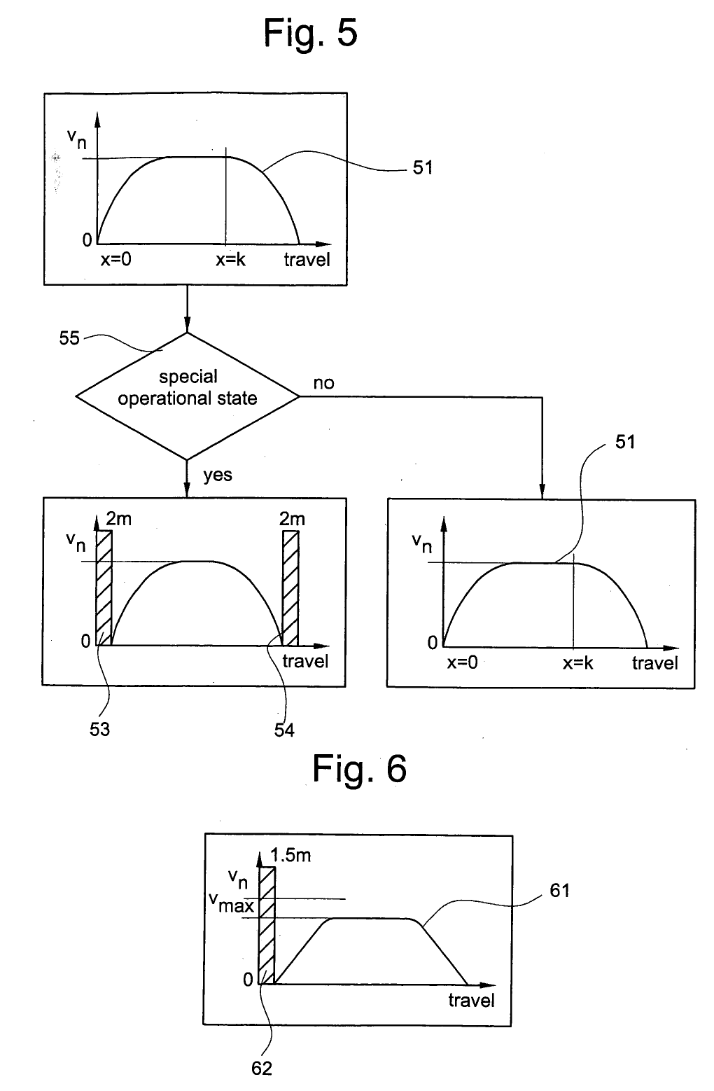

FIG. 5 shows a schematic flow chart according to one form of embodiment of the present invention;

FIG. 6 shows a diagram according to a further form of embodiment of the present invention;

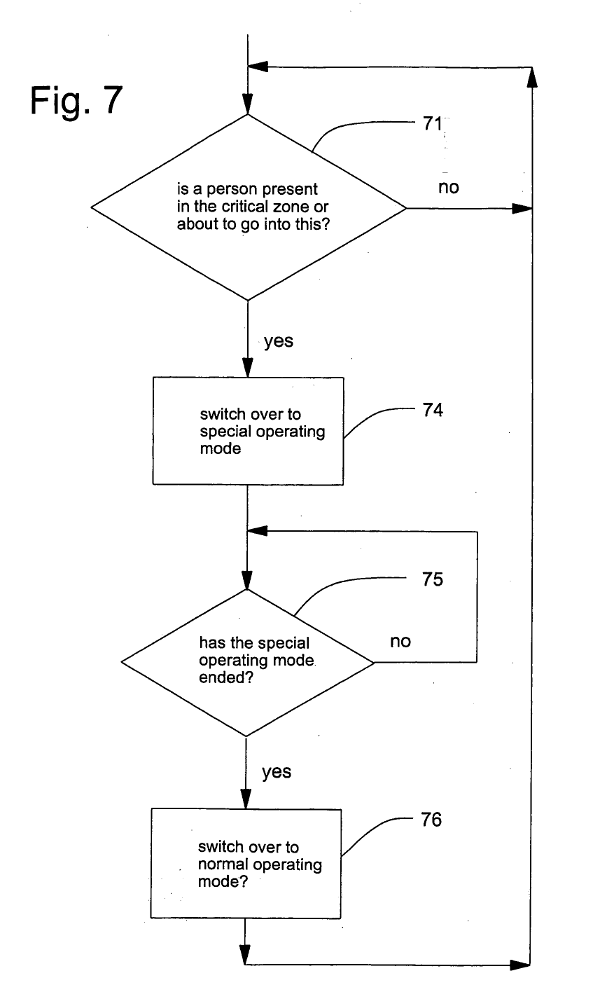

FIG. 7 shows a schematic flow chart according to a further form of embodiment of the present invention; and

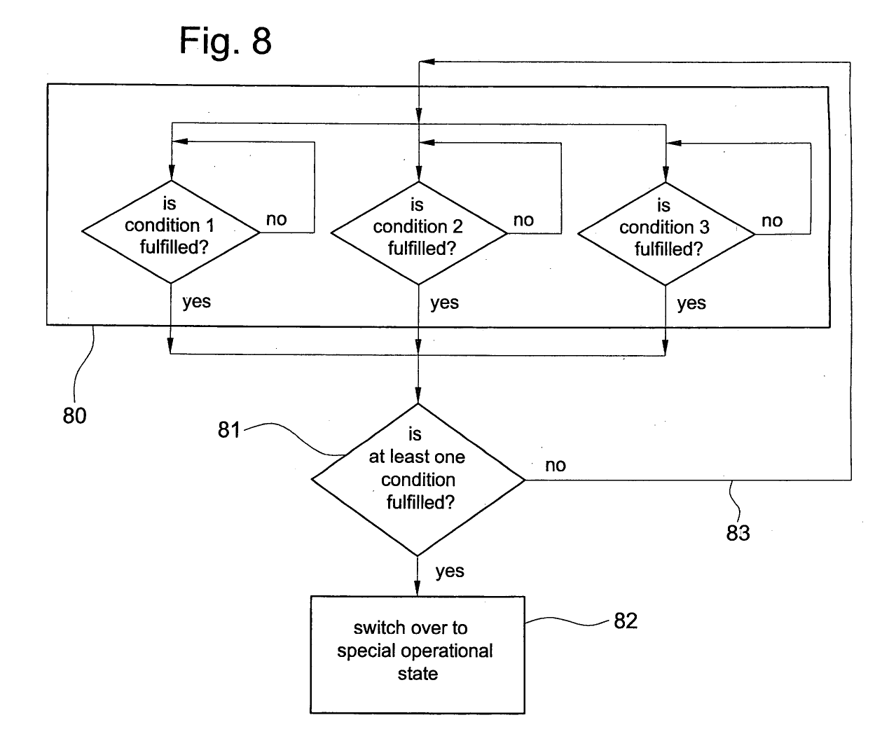

FIG. 8 shows a schematic flow chart according to a further form of embodiment of the present invention.

### DETAILED DESCRIPTION

The present invention is substantially independent of the form of lift layout and of the form of drive that is used. For these reasons in the following the cables or rails, counterweights and other elements are regarded as a constituent of the drive unit and are individually described or discussed only so far as necessary. In addition, the control is considered to be a constituent of the drive unit.

A conventional lift installation 10 is shown in FIG. 1. The illustrated installation 10 comprises a shaft 11 with a cage 12, which can travel to different floor levels 13.1 to 13.n. The drive unit comprises the cable 14.1, the rollers or suspensions 14.2 to 14.6, the drive motor (not illustrated) and the control unit for control of the drive motor (not illustrated). A shaft pit 15, which serves as a lower protective space, is disposed at the lower shaft end in accordance with regulations. A protective space 16 is provided at the upper shaft end so that a person located on the roof of the cage 12 is not put at risk.

An installation 20 according to the invention is illustrated in FIG. 2. The installation 20 comprises a lift cage 21 movable in a lift shaft 22 as indicated by the double arrow 23. The illustrated shaft 22 serves four floor levels 24.1 to 24.4. The cage 21 is driven by way of a drive unit 25. The drive unit 25 comprises a control unit 26 and a motor 27. The control unit receives input signals by way of an input 28, for example from a control keyboard (not illustrated) in the cage 21. The control unit 26 presets an appropriate speed curve in dependence on the input signals and correspondingly regulates the motor 27. The speed curve can be preset in the form of, for example, target values which are compared with extant actual values. In the case of deviations between the actual values and target values a regulating loop comes into effect in order to undertake corrections. The control unit 26 controls the cage 21 so that it can stop—according to the respective requirements—at the different storeys.

Additionally and in dependence on the usual sensors and control means (not shown in FIG. 2) necessary for normal operation of the lift installation 20 the lift installation comprises a detecting device 29 which detects whether a person stands in a critical zone of the shaft 22 or whether a person is about to go into a critical zone of the shaft 22. The end zone 32 at the lower shaft end and/or the end zone 33 at the upper shaft end (shaft head) is or are designated as critical zone or zones. Detection of the presence of a person on the cage roof or entry thereof onto the cage roof is preferably utilised for detection of entrance into the shaft head.

The detecting device 29 is connected with the drive unit 25 in such a manner, for example by way of a line or a bus 31, that the lift installation 20 is transferrable into a special mode of operation in case a person stands in the critical zone or is about to go into this. According to the invention the drive unit 25 comprises special control equipment 30 which can be integrated in the control unit 26 and which, in the special mode of operation, stops the lift cage at the latest before this moves into the critical zone 32 and/or critical zone 33. The detecting device 29 and the special control equipment 30 are designed in safety-relevant manner in order to prevent movement of the lift cage 21 into the critical zone 32 and/or critical zone 33 in all circumstances. During the special mode of operation the special control equipment 30 preferably enables undisturbed operation of the lift cage 31 in a zone outside the critical zone 32 and/or critical zone 33. In the illustrated example the lift cage 21 in the special operating mode can, for example, continue to serve the floor levels 24.2 and 24.3.

The term ‘safety-relevant’ is to be understood in the present connection in the sense that it concerns a lift installation which is reliable and, in particular, operationally safe in that, for example, the most essential components are present in redundant form, important functions of the control equipment (30; 42) elapse in parallel and the results thereof are compared with one another and the data transfer takes way by way of parallel lines or known methods for transmission error recognition are used for that purpose.

Through the use of a suitable detecting device and the special control equipment a virtual protection zone is created at the shaft base and/or at the shaft head at the latest on movement into the critical zone 32 and/or 33. The virtual protection zone must be absolutely safe in order to prevent risk to persons or even personal injury. Only if this is guaranteed is it possible to dispense with a shaft pit or an upper protective space.

Light barriers, light barrier grids, pressure mats, movement detectors, presence detectors, safety locks, door contacts, input units, operating mode selector switches, etc., are suitable as detecting device 29. The detecting device 29 is so conceived and arranged that it can recognise whether a person wants to enter a critical zone 32 and/or critical zone 33 or has entered. Ideally, several sensors are linked or combined into a detecting device 29 in order to improve the recognition or detection accuracy and in order to design this to be more reliable. The detecting device 29 delivers one or more signals or information to the special control equipment 30. The special control equipment 30 is so linked with the control unit 26 or integrated therein that an immediate switching over to the special mode of operation takes place automatically.

The elements of the detecting device can be arranged at different locations within or outside the shaft 22 and/or at the cage 21.

It is recommended to execute the detecting device 29 separately and independently of the usual sensors and control means of the lift installation 20 so as to ensure increased safety. In addition, the connection between the detecting device 29 and the special control equipment 30 should be constructed to be self-sufficient in relation to other systems or special safety measures should be undertaken.

For example, in a special form of embodiment of the invention there can be used a safety bus as is known from U.S. Pat. No. 6,173,814. Such a form of embodiment is illustrated in FIG. 3. In that case the sensors 40.1, 40.2 and 40.3 of a detecting device 43 are connected with the nodal points of a safety bus 41. The nodal points are illustrated in schematic form as dots. A controller 44 is disposed in the special control equipment 42 or is linked with the special control equipment in order to process and evaluate signals received by way of the safety bus 41. The special control equipment 42 can be designed to be programmable so that certain adaptations and subsequent updates can be undertaken. Rules can be preset which lead to switching over to the special mode of operation. In that case emphasis is placed on the highest possible safety as is demonstrated by way of the following example.

The detecting device 43 comprises three movement sensors 40.1, 40.2 and 40.3. The following rule can be set:

If the sensor 40.1 or the sensor 40.2 or the sensor 40.3 detects a movement,

then there is automatic switching over to the special mode of operation.

A further example could look as follows. In addition to the three movement sensors 40.1 to 40.3, there is also provided a light barrier 40.4 at the lowermost shaft door as shown in FIG. 4. The following rule can be predicated:

If the light barrier 40.4 detects that a person goes through the shaft door and

if the sensor 40.1 or the sensor 40.2 or the sensor 40.3 detects a movement,

then there is automatic switching over to the special mode of operation.

In FIG. 5 there is shown, on the basis of an exemplary curve 51, how a conventional lift can be controlled. The curve 51 shows speed as a function of travel x which the lift covers. In the illustrated case the travel length corresponds with the distance between the lowermost and uppermost floor level which the lift serves. The drive is so controlled not only during start-off, but also during braking, of the lift cage that low acceleration forces arise.

The curve 51 is a speed target value curve for a journey over the maximum travel path of the lift cage, for example for a journey from the storey above the shaft pit to the storey below the shaft head. Such a speed target value curve can obviously be generated, depending on the respective travel request, also over only one storey spacing or a few storey spacings. A lift installation is typically equipped with measurement transmitters which continuously measure actual values of cage position and cage speed and pass these on to the control unit (for example, the control unit 26 in FIG. 2). The speed actual values are then compared with the speed target values. The control unit determines therefrom whether there must be further acceleration, whether the lift can continue to be moved at the instantaneous speed or whether there has to be braking.

According to the present invention the lift installation automatically switches over to a special operating mode as soon as anybody is located in the shaft or intends to go into the shaft. An installation according to the invention is distinguished by the fact that the special operating mode enables independent influencing of certain control magnitudes.

In an advantageous form of embodiment the special control equipment 30 according to the invention is connected downstream of the actual control unit 26 of a lift installation and, in particular, so that the special operating mode always has priority over the normal operating mode. The manner of effect of an advantageous form of embodiment is shown in FIG. 5.

The speed target value curve 51 for the maximum possible travel path of the lift is shown in the uppermost box. The lift accelerates from standstill at x=0 metres to a normal speed vn. At this normal speed a major part of the travel path is covered up to the point x=k. At this point the braking process is initiated in order to bring the lift cage gently to a stop. As explained further above, such a curve is usually a speed target value curve. The drive unit of the lift is controlled by an actual value control in such a manner that the speed actual values correspond as closely as possible with the predetermined speed target value curve.

If the detecting device of the lift installation according to the invention recognises that there is switching over to the special operating mode, as illustrated in FIG. 5 by box 55, a changed control of the drive unit of the lift installation comes into being as indicated by the curve 52. Here the travel path range to which the maximum speed target value curve relates is reduced by the shaft regions to be protected. If switching over to the special operating mode has not been carried out, the speed target value curve 51 continues to be used.

According to the invention, the speed target value curve 51 is adapted to the operating mode by the special control equipment (for example, the special control equipment 30 in FIG. 2). If the lift installation is disposed in normal operating mode, then the speed target value curve 51 is used. In the special operating mode, thereagainst, the travel path which the lift cage can at most cover is shortened. This is schematically illustrated by the curve 52 in FIG. 5. In the illustrated example the characteristic course of the speed curve continues to be used. This means that the lift cage is accelerated and braked as also in normal operation. In addition, the normal speed vn remains unchanged in the illustrated example. Through shortening of the travel path two virtual protection zones 53 and 54 are created at the shaft foot and at the shaft head. In the illustrated example the height of the two virtual protection zones 53 and 54 amounts in each case to 2 metres.

In a further form of embodiment, which is schematically illustrated in FIG. 6, only one virtual protection zone 62 at the lower shaft end (at x=0 metres) is created. A form of embodiment of that kind, which in each instance provides only one virtual protection zone 62, can be used when the detecting device is designed so that it can distinguish whether a person stands in the lower or upper shaft region or is about to go into the lower or upper shaft region.

In order to further improve the safety of the lift installation according to the invention further measures can be undertaken, which are schematically indicated in the same FIG. 6. As a first measure the maximum speed vmax can be reduced in the special operating mode in order to avoid putting service personnel at risk. This can be important if, for example, service personnel stand on the roof of the lift cage. As a further measure, additionally or alternatively the start-up path and braking path can be designed so that lower acceleration forces arise. A longer time is then needed until the lift cage picks up speed, and the braking process has to be initiated earlier. In FIG. 6 both measures are used. The virtue protection zone 62 at the lower shaft end is, in the illustrated example, 1.5 metres, which can be sufficient as a protection zone depending on the respective constructional conditions.

Instead of the forms of embodiment described in connection with FIGS. 5 and 6, in which the special control equipment modifies the predetermined speed target value curve, there can be used special control equipment which independently takes over management of the drive control for the entire duration of the special operating mode. In this case the starting point is not the speed target value curve active in the normal operating mode, but the special control equipment presets a suitable curve. Such a curve can be derived from a memory or be generated from a table with parameters or with target values. If the lift installation is disposed in the special operating mode, then in the form of embodiment currently described the special control equipment takes over management of the drive control. In addition, in this form of embodiment a rule mechanism typically comes into use which measures the actual values of the lift installation and compares them with the target values in order to determine therefrom control magnitudes for the drive control.

In the variants of embodiment described in the foregoing in which the special operating mode contains the restriction of the travel range of the lift cage, the position thereof and preferably also the speed thereof are monitored at all times in safety-relevant manner so that in the case of movement of the lift cage into a protection zone the respectively provided braking process can be triggered immediately. Preferably, for the time being stopping is initiated by regulated braking of the drive. In the case of insufficient retardation of the lift cage, after a short test time, for example by means of opening relays of the drive control and brake control, an emergency stop is triggered by interruption of the current feed to the drive motor and to an electrically actuated device for keeping the drive brake open. If the detected course of braking should still be insufficient, then, after a further short test time, the safety brakes of the lift cage be activated.

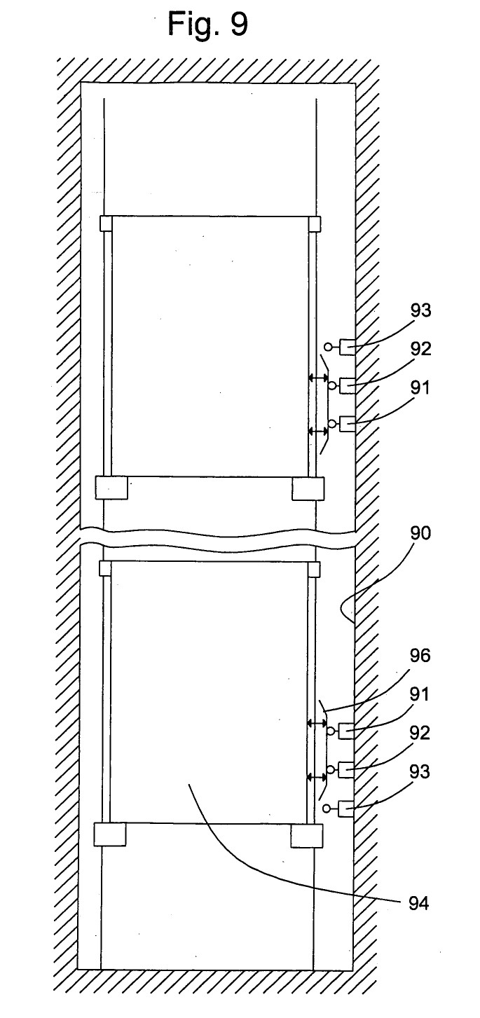

FIG. 9 shows a further variant of embodiment of a lift installation with a travel range restricted in the special operating mode. Sensors 91, 92, 93 are so mounted in the lift shaft 90 that they can detect movement of the lift cage 94 into the respective protection zone. They are activated in each instance only in the special operational state and, on detection of the lift cage, trigger stopping thereof. If in each instance several sensors are arranged in succession in travel direction, then, for example, a first sensor 91 can trigger stopping with regulated drive, a second sensor 92 can trigger the above-described emergency stop and a third sensor 93, which is appropriately spaced from the second, can trigger activation of the safety brake 95 of the lift cage. However, it is not absolutely necessary to use all mentioned braking stages.

As illustrated in FIG. 9, it can also be provided to actuate the afore-described sensors 91, 92, 93 only in the special operational state, in that a skid 96 is mounted at the lift cage to be retractable and extensible in such a manner that it actuates the sensors only in the extended state. The skid is extended each time in the special operational state, wherein this can take place by, for example, an electromagnetic actuator.

In addition, extending of the skid 96 can be realised by a device mechanically detecting the presence of a person on the cage roof, for example according to the principle of a lever balance. Equally, the sensors 91, 92, 93 mounted in the region of the shaft pit could be so displaced horizontally relative to the lift cage by a similar device detecting the presence of a person in the shaft pit that in this situation they can be actuated by a skid fastened to the cage.

According to a further form of embodiment of the lift installation the special control equipment is so designed or can be so influenced by maintenance personnel that on transition to the special operational state the lift installation is stopped without delay. In that case a moving lift cage is immediately stopped by interruption of the current feed to the drive motor and to an electrically actuated device for keeping the drive brake open, which can be produced by, for example, opening relays of the drive control and brake control. In the case of a version preferred in terms of safety, after expiry of a short test time the safety brakes at the lift cage can be activated if the resulting braking reaction was detected as insufficient.

In order to make the installation according to the invention safety-relevant, it is recommended to so design the special control equipment that on each occasion there is automatic switching over to the special operating mode as soon as there is detection by the detecting device of a state or a behaviour pattern which indicates that a person is located in the shaft or is about to go into this.

According to a further form of embodiment the lift installation is constructed so that every state which cannot be unambiguously interpreted by the special control equipment has the consequence that the installation is automatically transferred to the special operating mode. The special operating mode can be left again only after the presence of further measurement values of the detecting device or after an input has been manually effected. The safety of the lift installation is further increased by this measure.

Lift installations according to the present invention can be changed or adapted in that the detecting device is equipped with input means which make it possible for the service personnel to manually influence the control of the lift installation while they stand in the virtual protection zone. The corresponding input means should be constructed so that the virtual protection zones cannot, however, be prejudiced by the lift cage. The input means can comprise, for example, a card reader by which service personnel authenticate themselves. A control unit, by way of which the service personnel can influence the lift control, can be disposed adjacent to the card reader. It is also possible to furnish the service personnel with a portable data processing unit, for example in the form of a portable computer or a Personal Digital Assistant (PDA). The data processing unit can be coupled with the special control equipment by way of a cable connection or by radio or infrared radiation in order to be able to influence the control of the lift.

A further form of embodiment is distinguished by the fact that it comprises an indicating device which indicates whether the lift is disposed in the special operating mode. The indication can be carried out optically or acoustically or by other suitable means. The safety of the entire installation is thereby further increased, since the further personnel are informed by the indication whether switching over to the special operating mode has taken place in problem-free manner.

A further lift installation according to the invention comprises a card reader or a similar input unit which has to be actuated by service personnel before the lift shaft is entered. The special control equipment is transferred to a mode of alarm state by actuation of the input unit. If it is then detected by the detecting device that anybody actually passes through the doors to the shaft the special operating mode is activated.

On leaving the lift shaft an appropriate indication of departure can be undertaken in order to restore the lift to the normal operating mode.

A method of operating a lift installation according to the present invention is shown in the flow chart in FIG. 7. In a first step (illustrated by box 71) it is detected whether a person is located in the lift shaft or whether a person is about to go into this. This step 71 is preferably carried out by an appropriate detecting device which comprises one or more sensors or input means. If specific criteria are fulfilled, which signify or indicate that a person is located in the lift shaft or is about to go into this, there is switching over to the special mode as illustrated in box 74.

If the lift system is disposed in special operating mode, a transition to the normal operating mode has to take place a later point in time. There are various approaches to design a transition of that kind safely.

It is particularly important not to trigger premature or unwarranted switching back to the normal operation. Special safety measures help to avoid this.

For example, the signals of the detecting device can be continuously used in order to obtain a statement about whether anybody is located in one of the critical zones of the lift shaft. If this should not be the case, then switching back to the normal operation can take place, as indicated in boxes 75 and 76. Advantageously switching back takes place only with a certain delay in time in order to increase safety.

Every situation which is only imaginable should be taken into account in the concept of the installation according to the invention. How does the system behave if service personnel are motionless in the shaft over a longer period of time? What happens if one person leaves the shaft, but another person continues to stay in the shaft? The detecting device should comprise appropriate components, in the form of sensors and other detecting means, to enable a safe decision for all eventualities according to clear rules.

In FIG. 8 it is illustrated that the detecting device 80 can interrogate several conditions in parallel. In the illustrated example three different conditions 1 to 3 are shown. The condition 1 can, for example, be formulated as follows:

Does a movement sensor report movements in the shaft?

The condition 2 can be formulated, for example, as follows:

Does an infrared sensor report a warm body or object in the detecting range?

The condition 3 can be formulated, for example, as follows:

Is the light beam of a light barrier interrupted permanently or from time to time?

As shown in FIG. 8 by the box 81, any one of the conditions, if it is fulfilled, should trigger switching over to the special operating mode. The step of switching over is shown in box 82. If no switching over takes place, then the flow chart follows the path 83 back to the point where the detecting device is set to continue monitoring.

If the lift installation is already disposed in the special operating mode, other rules or conditions can come into use. In addition, the various sensors can be linked or the signals evaluated by way of a logic system in order to be able to undertake safer decisions.

In a specific form of embodiment the special control equipment is designed so that it is secure against failure. In other words, if a disturbance should happen in the lift system it has to be ensured on every occasion that the virtual protection zone or zones is or are maintained. For this purpose, for example, special safety circuits can be used which ensure on every occasion a transfer to the special operating mode.

The various aspects and features of the individual forms of embodiment can be combined with one another without further measures. In addition, features or advantageous elements which were described or illustrated in conjunction with a specific form of embodiment can be used in conjunction with other forms of embodiment.

Translation of legends in the drawings

FIG. 5:

Weg=travel

Spezieller Betriebszustand=special operational state

Nein=no

Ja=yes

FIG. 6:

Weg=travel

FIG. 7:

Ist eine Person in der kritischen Zone

anwesend oder im Begriff, in diese

zu gelangen?=is a person present in the critical zone or about to go into this?

In speziellen Betriebsmodus umschalten=switch over to special operating mode

Speziellen Betriebsmodus beenden?=has the special operating mode ended?

In normalen Betriebsmodus umschalten?=switch over to normal operating mode?

Nein=no

Ja=yes

FIG. 8:

Ist Bedingung 1 erfüllt?=is condition 1 fulfilled?

Ist Bedingung 2 erfüllt?=is condition 2 fulfilled?

Ist Bedingung 3 erfüllt?=is condition 3 fulfilled?

Ist mindestens eine Bedingung erfüllt?=is at least one condition fulfilled?

In speziellen Betriebszustand umschalten=switch over to special operational state

Nein=no

Ja=yes

1. Lift installation (20) with a lift cage (21), a lift shaft (22) and a drive unit (25), wherein
the lift shaft (22) is equipped with a detecting device (29; 43) which detects whether a person stands in a critical zone (32, 33) in the lift shaft (32) or is about to go into this,
the detecting device (29; 43) is connected with the drive unit (25) in such a manner that the lift installation (20) is transferrable into a special operating mode in case a person stands in the critical zone (32, 33) or is about to go into this, and
the drive unit (25) comprises special control equipment (30; 42) which in the special operating mode prevents movement of the lift cage (21) into the critical zone (32, 33),
characterised in that the special control equipment (30; 42) is so designed that in the special operating mode the operation of the lift cage is possible outside the critical zone (32, 33) without restriction.

2. Lift installation according to claim 1, characterised in that the detecting device (29; 43) comprises one or more sensors (40.1 to 40.4).

3. Lift installation according to claim 2, characterised in that the sensor or sensors (40 to 40.4) is or are linked with the special control equipment (30; 42) by way of a line (31) or a bus (41).

4. Lift installation according to claim 3, characterised in that the detecting device (29; 43) and the special control equipment (30; 42) are designed in safety-relevant manner in order to ensure a high level of failure safety, i.e. that, for example, the essential components are present in redundant form, important functions of the control device (30; 42) elapse in parallel and the results thereof are compared with one another and the data transmission takes place by way of parallel lines or for that purpose known methods for transmission error recognition are employed.

5. Lift installation according to claim 5, characterised in that a control (25) is provided which can be linked with the special control equipment (30; 42) or in which the special control equipment (30; 42) is integrated.

6. Lift installation according to claim 5, characterised in that the detecting device (29; 43) comprises a bus, preferably a safety bus (41).

7. Lift installation according to one of claims 1 to 6, characterised in that a target value/actual value control is provided.

8. Lift installation according to claim 7, characterised in that the special control equipment (30; 42) converts the target value curve of the target value/actual value control by computation in order to thus ensure a virtual protection zone at the lower shaft end and/or a virtual protection zone at the upper shaft end.

9. Lift installation according to one of claims 1 to 6, characterised in that the special control equipment (30; 42) takes over control of the drive unit in the special operating mode in order to thus ensure a virtual protection zone at the lower shaft end and/or a virtual protection zone at the upper shaft end.

10. Lift installation according to one of claims 1 to 6, characterised in that the special control equipment (30; 42) is rule-based control equipment which makes decisions on the basis of preset or presettable rules.

11. Method of controlling a drive unit (25) of a lift installation (20), which moves a lift cage (21) in a lift shaft (22), wherein the method comprises the following steps: detection by means of a detecting device (29; 43) whether a person stands in a critical zone (32, 33) within the lift shaft (22) or is about to go into this and automatic switching over of the drive unit (25) to a special operating mode in case a person stands in a critical zone (32, 33) or is about to go into this, wherein the control of the lift cage (21) in the special operating mode is influenced by way of special control equipment (30; 42) in such a manner that movement of the lift cage (21) into the critical zone (32, 33) is prevented, characterised in that the lift cage (21) after switching over to the special operating mode can continue to move in a zone outside the critical zone (32; 33).

12. Method according to claim 11, characterised in that the detecting device (29; 43) passes on signals or information to the special control equipment.

13. Method according to claim 12, characterised in that the special control device decides on the basis of the signals or information whether switching over to the special operating mode takes place.

14. Method according to claim 13, characterised in that the detecting device comprises one or more sensors (40.1 to 40.4) which are evaluated or interrogated in the detecting.

15. Method according to one of claims 11 to 14, characterised in that the special control equipment (30; 42) converts the target value curve of the target value/actual value control by computation or activates a stored target value curve in order to thus ensure a virtual protection zone at the lower shaft end and/or a virtual protection zone at the upper shaft end.

16. Method according to one of claims 11 to 14, characterised in that the special control equipment (30; 42) takes over control of the drive unit in the special operating mode in order to thus ensure a virtual protection zone at the lower shaft end and/or a virtual protection zone at the upper shaft end.

17. Method according to one of claims 11 to 14, characterised in that the special control equipment (30; 42) is rule-based control equipment which makes decisions on the basis of preset or presettable rules in that it checks conditions and triggers an automatic switching over to the special operating mode when one or more of the rules is or are fulfilled.

18. Method according to one of claims 11 to 14, characterised in that the special control equipment (30; 42) cancels the special operating mode after occurrence of an event.

19. Method according to claim 18, characterised in that the event is triggered manually, for example by way of a manual input, or automatically.

20. Method according to one of claims 11 to 14, characterised in that during the special operating mode the lift cage is moved at reduced speed and/or with low start-off and braking accelerations and/or with shortened travel path or is not moved at all.
